(19) United States
(12) Patent Application Publication
(10) Pub. No.: US 2017/0270589 A1
(43) Pub. Date: Sep. 21, 2017

(54) Techniques for Shopping Recommendations Based on Social Ties

(71) Applicant: International Business Machines Corporation, Armonk, NY (US)

(72) Inventors: Keith W. Grueneberg, Stewart Manor, NY (US); Bong Jun Ko, Harrington Park, NJ (US); Christian Makaya, Summit, NJ (US); Jorge J. Ortiz, New York, NY (US); Swati RaIlapaIli, Ossining, NY (US); Theodoros Salonidis, Boston, MA (US); Rahul Urgaonkar, Shoreline, WA (US); Dinesh C. Verma, New Castle, NY (US); Xiping Wang, Scarsdale, NY (US)

(21) Appl. No.: 15/074,673

(22) Filed: Mar. 18, 2016

(51) Int. Cl. G06Q 30/06; G06Q 20/32; G06Q 30/02; G06Q 50/00

(52) U.S. Cl. CPC G06Q 30/0631; G06Q 50/01; G06Q 20/322; G06Q 30/0217

(57) ABSTRACT

Techniques for making shopping recommendations based on a user's social ties to friends and family are provided. In one aspect, a method for making shopping recommendations is provided. The method includes the steps of: collecting shopping data from users, wherein the users comprise a first user and one or more second users with social ties to the first user; and making recommendations to the first user based on the shopping data while the first user is shopping at a store, wherein the recommendations include preferences of the second users with social ties to the first user. A system for making shopping recommendations is also provided.

### FIELD OF THE INVENTION

The present invention relates to shopper assistance and physical analytics, and more particularly, to techniques for making shopping recommendations based on a user's social ties to friends and family.

### BACKGROUND OF THE INVENTION

Analyzing physical browsing of users in brick and mortar stores enables one to better understand user behavior in the physical world and to leverage that knowledge in assisting users in their shopping decisions. Techniques have been proposed to analyze a shopper's purchase history. See, for example, U.S. Pat. No. 6,129,274 issued to Suzuki, entitled “System and Method for Updating Shopping Transaction History Using Electronic Personal Digital Shopping Assistant.” Techniques have also been proposed for suggesting a shopping route based on prior shopping history. See, for example, U.S. Patent Application Publication Number 2008/0154720 by Gounares et al., entitled “Shopping Route Optimization and Personalization.”

Current solutions for analyzing shopping decisions focus primarily on the preference of an individual shopper and base recommendations on the shopper's past shopping history. Shopping decisions, however, aren't always based solely on the shopper's preferences. For instance, current solutions do not assist users in their shopping decisions in relation to their family and/or friends. Take for example the situation where a user is shopping for an item for a family member or friend, e.g., as a gift, as an item the family member/friend needs at home, etc. No system currently exists for making shopping recommendations for the user's family/friends.

Accordingly, improved techniques for making shopping recommendations based on a user's preferences, as well as the preferences of the user's family and friends, would be desirable.

### SUMMARY OF THE INVENTION

The present invention provides techniques for making shopping recommendations based on a user's social ties to friends and family. In one aspect of the invention, a method for making shopping recommendations is provided. The method includes the steps of: collecting shopping data from users, wherein the users comprise a first user and one or more second users with social ties to the first user; and making recommendations to the first user based on the shopping data while the first user is shopping at a store, wherein the recommendations include preferences of the second users with social ties to the first user.

In another aspect of the invention, a system for making shopping recommendations is provided. The system includes: at least one store having a recommendation engine configured to: collect shopping data from users, wherein the users comprise a first user and one or more second users with social ties to the first user; and make recommendations to the first user based on the shopping data while the first user is shopping at the store, wherein the recommendations include preferences of the second users with social ties to the first user.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary system for making shopping recommendations based on social ties according to an embodiment of the present invention;

FIG. 2 is a diagram illustrating an exemplary methodology for making shopping recommendations based on social ties according to an embodiment of the present invention;

FIG. 3 is a diagram illustrating an exemplary methodology for detecting social ties based on user trajectories according to an embodiment of the present invention;

FIG. 4 is a diagram illustrating an exemplary methodology for marking products liked by a user according to an embodiment of the present invention; and

FIG. 5 is a diagram illustrating an exemplary apparatus for performing one or more of the methodologies presented herein according to an embodiment of the present invention.

### DETAILED DESCRIPTION OF PREFERRED EMBODIMENTS

As provided above, shoppers can be aided by tools that make recommendations to the shopper based on their past purchases. For instance, when a user is shopping at a grocery store, the user's past shopping history at that store can be leveraged to make recommendations about what the user should pick up on their current visit. For example, if the user typically buys milk, bread and eggs at every visit to that store, then it would be helpful to remind the user if he/she has forgotten to pick up any of these items. Stores typically track purchases made by a user, such as through a loyalty card, therefore purchase history data is readily available.

Tracking an individual user's purchase history to make shopping recommendations is, however, only one aspect of a shopping experience. Users regularly make purchases based on other's preferences and past shopping histories, such as those of their family and friends. To date, no solutions exist for a user to take into account the shopping preferences of his/her family/friends in a seamless manner.

For instance, when shopping for a household, a user might not know what other family members typically purchase. As a result, the user might miss items and/or buy items, brands, etc. that are not what other family members want. Also, other family members might have an established shopping route through a particular store that enables them to easily find the items they like (i.e., based on a given layout of the store) and/or to seek out particular deals, specials, etc. It would be desirable for a person to be able to leverage this information to use this same route through the store, vastly cutting down on the time needed to find each of these items in a random fashion. That way, even if a user is unfamiliar with a particular store, he/she can easily determine what (and where) each item that members of the family typically buy is in the store.

Another example might be a situation where a user wants to buy a gift for a friend or family member. When visiting a store, the user would greatly benefit from knowledge about which items in the store, areas of the store, etc. that friend or family member typically purchases or visits. This information would help reduce the guessing in making the purchase. Also, for example, say that a user sees an item at a store that he/she knows a family member or friend might like to purchase. There is currently no convenient way to alert the family member/friend when they visit that store about the item.

Advantageously, provided herein are techniques for identifying family and friends of a user, and for leveraging family and friend preferences in making shopping recommendations to the user. The present techniques employ smart mobile technology (e.g., smart phone, smart watch, smart glasses, etc.) to establish connections between users (i.e., to determine family and friend connections), collect shopping preference data, and make shopping recommendations.

The present techniques enable customized shopping assistance to aid shoppers by leveraging their physical analytics data. For instance, when shoppers are not sure of what to buy, the present system reminds them of the items bought in the past and their locations in the store, along with recommended items (e.g., similar items, items which are on sale, or when they will go on sale, etc.). The present system allows family physical browsing data to be used automatically using mobile phones, i.e., family and social ties are automatically detected and can be used to help shoppers in deciding what to buy and where in store to pick up the items from. Some other notable benefits of the present system include: enabling usage of data from user end as well as store end from multiple store locations visited by user, e.g., using data from all of a particular brand of stores visited by user, and data collected both on the user's smart mobile device(s) as well as the store's purchase tracking system, surveillance system, etc.; reducing the amount of data to be shipped to the server by processing the raw data locally at the mobile device itself; helping shoppers not to forget to buy the items they need.

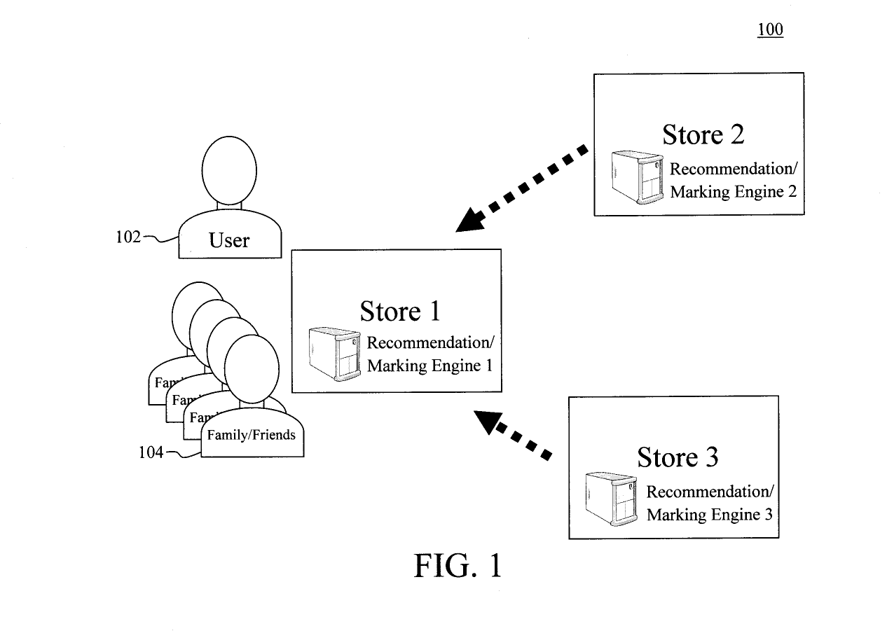

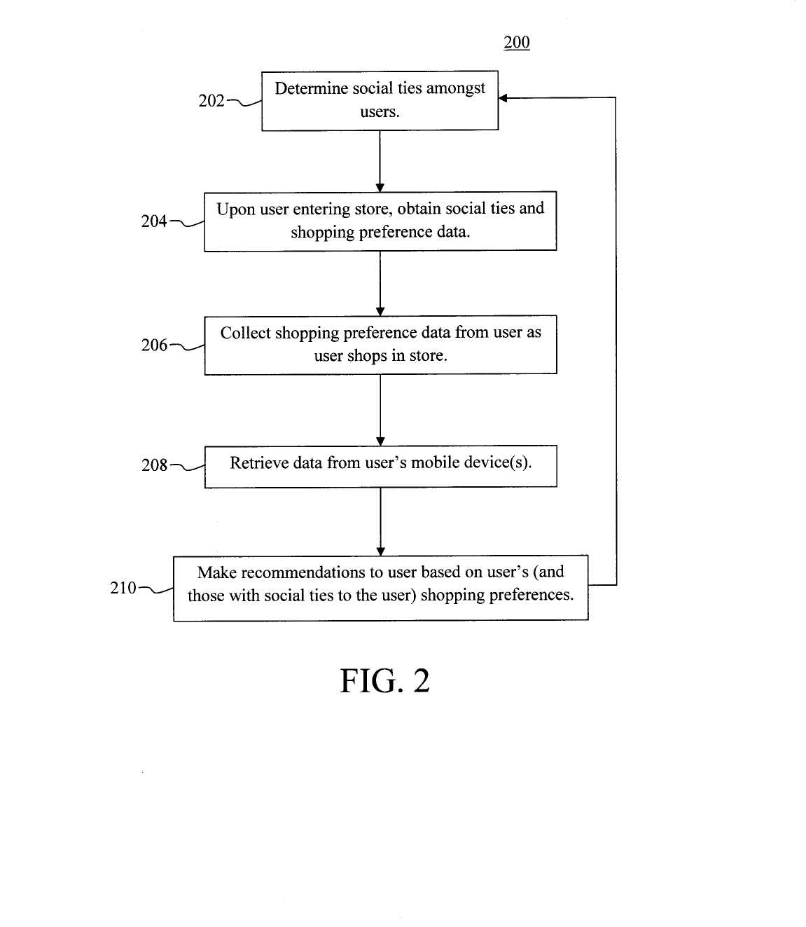

A description of the present system architecture 100 and implementation details are now described by way of reference to FIG. 1 and exemplary methodology 200 of FIG. 2. As shown in FIG. 1, it is assumed that a plurality of users shop at one or more of Store 1, Store 2, and Store 3. For illustrative purposes only, FIG. 1 singles out one of the users (i.e., user 102) as the target user—e.g., the user for which shopping recommendations will be made—and one or more other of the users (i.e., users 104) which represent users with social ties (i.e., family/friends) to user 102. As will become apparent from the following description, the present techniques can be applied to any of the users shopping at any of the Stores 1-3. Thus, any of the users depicted in FIG. 1 can represent the family/friends of one or more other users in accordance with the present techniques.

It is further assumed that Store 1, Store 2, and Store 3 share data related to the shopping preferences of user 102 and family/friends 104 of user 102. For instance, according to one exemplary embodiment, Store 1, Store 2, and Store 3 are separate units of the same chain (e.g., units with the same chain of grocery stores, department stores, etc.). However, other cooperative data sharing structures can be envisioned. For instance, stores within the same shopping center, state, city, town, etc. can share shopper preference data in the manner described herein.

Referring now to methodology 200 of FIG. 2, first off in step 202 social ties between the users are determined. As noted above, in the instant example, any of the users can represent social connections (i.e., family/friends) of any one or more other users. Thus, the first task is to determine who are family/friends (i.e., referred to herein generally as “social ties”). This can be accomplished in a number of ways. According to an exemplary embodiment, it is proposed that users shop together with friends and family. Thus, a convenient way to establish social ties between users is to detect users that are present in the same store at the same time. For instance, the presence of users can be established based on their mobile devices. Mobile devices, such as smart phones, watches, glasses, etc. are typically carried on the person. Each of these mobile devices can be detected upon entry into the store. It is assumed in this case that each mobile device is personal to a particular user. However, even if it is a shared device (e.g., family members might share a mobile device) the present techniques can be employed to leverage collective preferences of a family or friends group. The identity of a user can, but needs not be, the user's name. For instance, each mobile device can be detected based on a unique identifier, such as a MAC ID, etc. It could be some other user's ID as well if there is a store app installed on the device communicating with the store server over the WiFi once the user enters the store.

By way of example only, a (predetermined) threshold can be set for the number of times two (or more) mobile devices are spotted in the same store at the same time to establish a social tie between the respective users. For instance, the threshold can be anywhere between 3-10 times for a given (predetermined) time period, e.g., from about 1 week to 1 month. Setting a threshold will eliminate erroneous connections made merely by chance. To use a simple example, if the mobile devices of a User A and a User B are detected in the same store more than 5 times within a one month period, then it may be assumed that User A and User B have social ties to one another. It is unlikely that strangers would happen to be in the same place at the same time more than 5 times in a month-long period. Additional mechanisms can also be implemented to prevent erroneous ties between users. By way of example only, the condition can be imposed that users (e.g., User A and User B) shop at multiple (i.e., more than one) stores together. Also, the user whose preferences are to be shared with his/her friends could be asked if he/she would like the products to be recommended to a particular person.

It may be the case that some users with social ties do not shop together. However, as mentioned above, many stores issue shoppers loyalty cards. These cards are uniquely tied to an individual shopper and are typically registered whenever the shopper makes a purchase. Further, family members might, as a group, get loyalty cards tied, e.g., to the same account. Thus, establishing social ties might be done simply by determining which loyalty cards are on the same account.

Other metrics are anticipated herein for establishing social ties amongst users that take into account a variety of different shopping habits, and apply to many real-world scenarios. For instance, users with social ties often might not visit a store at the same time. For example, family members often shop at different times based on their individual work, school, etc. schedules. Even if users shop in a store at the same time, they often linger at different parts of the store while shopping. As will be described in detail below, techniques are presented herein for employing user trajectory analysis to determine social ties. Namely, current mobile technology permits tracking of user movements via a series of time-stamped locations, referred to in the art as ‘trajectories.’ See, for example, Zheng et al., “GeoLife: A Collaborative Social Networking Service among Users, Location and Trajectory,” IEEE Data Eng. Bull. 33(2):32-39 (2010), the contents of which are incorporated by reference as if fully set forth herein. Thus, trajectories permit the collection of a knowledge base of location history for users.

According to an exemplary embodiment, data relating to the social ties of the users (as well as the purchasing history/shopping preferences of the users) is stored locally in each of the stores—e.g., in a recommendation engine (see local Recommendation Engines 1, 2, 3, in Stores 1, 2, 3, respectively, in FIG. 1). The recommendation engines (Recommendation Engines 1, 2, 3) are configured to communicate this data from one store (Stores 1, 2, 3) to another. Thus, the collective shopping social ties and shopping preference data can be leveraged over a collection of stores. This collaborative data collection capability has notable benefits. For instance, a user might shop together with family/friends at a store close to home, but not at a store near work. Thus, if looked at independently, certain social ties might be missed for certain stores. However, with the collective data the user can benefit from knowing the shopping preferences of his/her family/friends both when shopping near home or near work. Also, family or friends of the user might shop at different stores. The collective data, however, will highlight their shopping preferences. Each of Recommendation Engines 1, 2, 3 local to Stores 1, 2, 3 can perform the steps of methodology 200.

In step 204 (of FIG. 2), when a user enters a store, the store retrieves the social ties and shopping preference data it has for the user, and preferably the data that other stores have for the user. As provided above, this data may be stored locally in each of the stores at which the user/user's family and friends shop. For example, by way of reference to FIG. 1, when the presence of user 102 is detected at Store 1, the system at Store 1 retrieves the i) a list of the users 104 to which the user 102 has social ties, ii) the shopping preferences for user 102, and the shopping preferences for those users with social ties to user 102. This social ties/shopping preference data can pertain to a single store (Store 1 for example), or preferably to multiple stores (Stores 1-3 for example). Take for example the situation where Stores 1-3 are all units within the same chain of stores. As provided above, data can be exchanged between the various units. This configuration where data is shared amongst units helps capture shopping trends over a broader scale. In that case, by way of reference to FIG. 1, when the user 102 enters Store 1 the social ties and shopping preference data for the user 102 is retrieved from Stores 1-3. It may be the case that the user 102 has not shopped at Store 1 with any of his/her family/friends. Thus if one were to focus solely on a single store, then no social ties would be established for the user 102. However, it may be the case that the user routinely shops at Store 2 and/or Store 3 with his/her family/friends. Thus, by retrieving data from all of Stores 1-3, a broader scope of social ties can be established. Further, perhaps none of the user's family/friends have ever shopped at Store 1, however they routinely shop at Store 2 and/or Store 3. Looking solely at Store 1 would not yield helpful family/friend shopping preference data. However, by expanding the scope of the data to Stores 2 and 3 would be successful in yielding family/friend shopping preference data.

As highlighted above, the presence of a user in a given store can be established via the mobile device(s) the user carries on their person. Other ways for establishing the presence of a user at a store can include use of a loyalty card by the user. Further, some stores may have a kiosk or desk where users can check in using their loyalty card. As an incentive, users may be given coupons, suggestions for items (based on their preference and/or the preference of their social ties), etc. when they check in. Thus, according to an exemplary embodiment, methodology 200 (of FIG. 2) is commenced when the user enters the store and swipes his/her loyalty card.

It is notable that, while the instant description presents a series of steps, it is to be understood that the various tasks described may be performed simultaneously and/or in an order different than described/depicted. For example, according to methodology 200 (of FIG. 2), social ties and shopping preference data may be collected from one or more users while, at the same time, data that has been collected is used to make recommendations to one or more other users. Further, as will be described in detail below, the present process is iterative in the sense that data is being continually collected and feedback to the user is constantly updated based on that data. For instance, the present techniques may be implemented in the situation, e.g., where user 102 is shopping at Store 1 at the same time one or more of users 104 (family/friends of user 102) are shopping at Store 2 and/or Store 3. Data collected from Stores 1-3 can be used to augment the shopping experience for the users 102 and 104 in real-time. Thus, if the users 104 find an item(s) of interest, on sale, etc. in Store 2 or Store 3, then user 102 may be alerted to this while he/she shops in Store 1, and vice versa.

In step 206 (of FIG. 2), data is collected from the user as the user shops in the store. The types of data collected in step 206, and the means of collecting the data can vary. For instance, shopping preference data can be collected from the user via the user's mobile device(s). For example, the user might have a shopping list stored on their smartphone or watch, and may agree to share that information with the store (e.g., via Bluetooth-enabled technology). Similarly, users may take photos of products they like using the camera on their smartphone, or use an app on their smartphone to scan a barcode or a mini/micro matrix barcode quick response (QR) code on the label of a product. The user might agree to share this information about their shopping preferences. Further, some stores provide handheld scanners for shoppers to take around the store and scan the barcodes on products they purchase or would like to purchase. The shoppers can permit that information to be stored to establish their shopping preferences.

Other useful data that may be obtained in step 206 is the user's browsing path through the store. For instance, it may be useful to know which departments, sections, aisles, etc. of the store the user visits, how frequently, and how long the user spends browsing these sections. Sections of the store that the user browses most frequently can be assumed to be of interest to the user. Further, the browsing history of the user might be helpful in establishing purchasing/browsing patterns. For instance, a particular user might routinely take a certain path through a grocery store which enables them to find the items, brands, specials, they want. This data can be leveraged to inform other users with social ties an efficient route through the store to find these items.

The browsing path data can be obtained using, for example, the store's surveillance system. For instance, stores typically employ camera systems to monitor shoppers. Shoppers might consent to those images being used to determine their movements throughout the store. Tracking algorithms are well known in the computer vision field that can be used to monitor movements based on images from the surveillance system. See, for example, Yilmaz et al., “Object Tracking: A Survey,” ACM Computing Surveys, vol. 38, no. 4, Article 13, pgs. 1-45 (December 2006), the contents of which are incorporated by reference as if fully set forth herein. Additionally, electronic beacons may be used throughout the store which send identifier data (via Bluetooth technology) to users' mobile devices when in close proximity. Thus, a shopper's route through the store may be established based on the beacons the shopper's mobile device passes.

From the above, it is apparent that the data collection process can involve data collected from the store side (e.g., surveillance data, loyalty card data, store-provided scanner data, etc.) as well as data collected by the shopper (e.g., mobile device data, such as shopping lists, mobile app barcode scanned data, photos, etc.). In order to enhance their shopping experience, users might consent to this data collected via their mobile devices to be retrieved by the store. This data retrieval is performed in step 208.

Other data that can be obtained from the user in step 206 relates to products the user specifically marks/tags as being something the user likes. Namely, as will be described in detail below, the present techniques offer users the option to mark products while shopping that the user likes. The users can then go back at their leisure (so as not to interrupt their shopping experience) and validate/provide the reasons why they liked a particular product (e.g., it is a good product, it is on sale, the coffee from a particular coffee machine is hot, the size of the table is right for a mid-size living room, etc. this information is much richer than marking the products you see online, as in the brick and mortar retail store, you get to describe the look and feel as well and that is the power of this system). This data can then be used in making recommendations to the users' social ties. According to an exemplary embodiment, this marking process is carried out locally in each of the stores—e.g., via a marking engine (see local Marking Engines 1, 2, 3, in Stores 1, 2, 3, respectively, in FIG. 1). The marking engines (Marking Engines 1, 2, 3) are configured to communicate this data from one store (Stores 1, 2, 3) to another.

In step 210, the data collected from the store side (e.g., via step 206) and/or the data collected from the shopper/user side (e.g., via step 208) is then analyzed to determine shopping preferences. For instance, in its simplest form, the list of items the user purchased is used in step 210 to establish a list of products favored by the user. However, as provided above, the present process is performed in an iterative manner, and data is collected every time the user shops at the store(s). Thus a more detailed shopping history can be established using archived data which reflects shopping trends, preferences etc. over time. For example, the user might purchase a certain item on one visit, and then never again. That might in fact indicate that the user didn't like the product, and thus is not something to recommend for future purchase. The user might purchase a particular item(s) only at certain times of the year, such as certain produce in the summer, or certain clothing (e.g., jackets, hats, etc.) in the winter. By evaluating a purchase history, these trends can be revealed.

As highlighted above, browsing history can also provide useful information. For example, the particular browsing patterns the user and/or the user's family/friends take through a particular store or chain of stores can help establish preferences. For instance, individual units within the same chain of stores often have a similar layout. Thus, the browsing history in one unit can be useful for making recommendations for other units. Further, even if the layouts of the units differ, the present analysis can zero in on the particular departments, sections, etc. the users visited (and preferably in what order, how frequently, etc.).

Based on the analysis performed in step 210, recommendations are made to the user about his/her shopping preferences and those of the users he/she has social ties to. For instance, the user's own preferences may be used to make recommendations based on past purchases to remind the user not to forget to purchase something they may need, to make suggestions for things the user might like, etc. These recommendations can extend beyond products the user has purchased in the past. For instance, based on the user having purchased an item X in the past, the present techniques may be employed to suggest another product of the same brand, type, use, that the user might like, another brand of the same type of product that might currently be on sale, etc.

Regarding recommendations of products purchased by family/friends, the user might not know what items his/her family/friends like to purchase. With the present techniques, the data collected from those having social ties to the user can be used to make recommendations for purchases. Take for instance the example from above where a user is shopping for a household, the user might not know the items, brands, quantity, etc. each of the members of the household likes. Without guidance, the user would likely miss a number of these items (or purchase an incorrect brand, quantity, etc.) he/she needs to purchase for the household. The same applies in situations where a user might be purchasing a present for a family member or friend. The present techniques can provide recommendations based on the user's family/friends previous purchases and/or browsing history.

Further, the user might not be shopping for another, but the user might have similar tastes as a family member or friend. The user might benefit from knowing what the family member or friend found interesting at a store so that the user might consider the product as well. If the user seeks out the product then, based on the present techniques, that product can be associated with the user him/herself and/or be available for recommendation to other family/friends of the user, etc.

The recommendations can be made to the user in step 210 in a variety of different ways. For instance, recommendations can be made to the user via his/her mobile device. For instance, using FIG. 1 as an example, Store 1 might send a text message to a smart phone, watch, etc. of user 102 suggesting products in Store 1 that user 102 and/or family/friends of user 102 has/have purchased in the past (at Store 1 and/or at related Stores 2 and 3), similar products, related items (e.g., products that are typically used along with another product), etc. The message might be sent as the user 102 enters Store 1 and/or as user 102 makes his/her way through the store. For instance, messages might be sent to the user's mobile device(s) regarding products that are relevant to the section the user is currently shopping. As provided above, technology such as electronic beacons can be used to determine shopper locations throughout a store.

Alternatively (or addition to) sending mobile device messages, the user might be able to retrieve recommendations via a monitor, printout, etc. provided at a front desk of the store and/or kiosks at one or more locations in the store. Users can be uniquely identified based, for example, on their loyalty card, mobile device signatures, etc.

As provided above, and as shown in FIG. 2, the present system iteratively monitors and collects shopper data. Thus, real-time updates, social ties, and recommendations may also be made/established. For instance, if a family/friend of the user is currently shopping at the same or another related store, data about that shopper's purchases can be provided to the user. For example, if a family member/friend of the user finds an item of interest that has just gone on sale, then the user can be alerted so he/she might also take advantage of the sale price.

As noted above, users are given the option of whether or not they want their data collected and/or shared. This can be regulated at different levels. For instance, a user might opt out of the process altogether. In that case, data will not be collected from that user and the user will not receive data about other users to which he/she has social ties. Alternatively, a user might consent to his/her data being collected and recommendations being made based on his/her own past purchases, but not to share any of this information with family/friends. Alternatively, a user might consent to collecting/receiving/sharing all shopping data with family/friends.

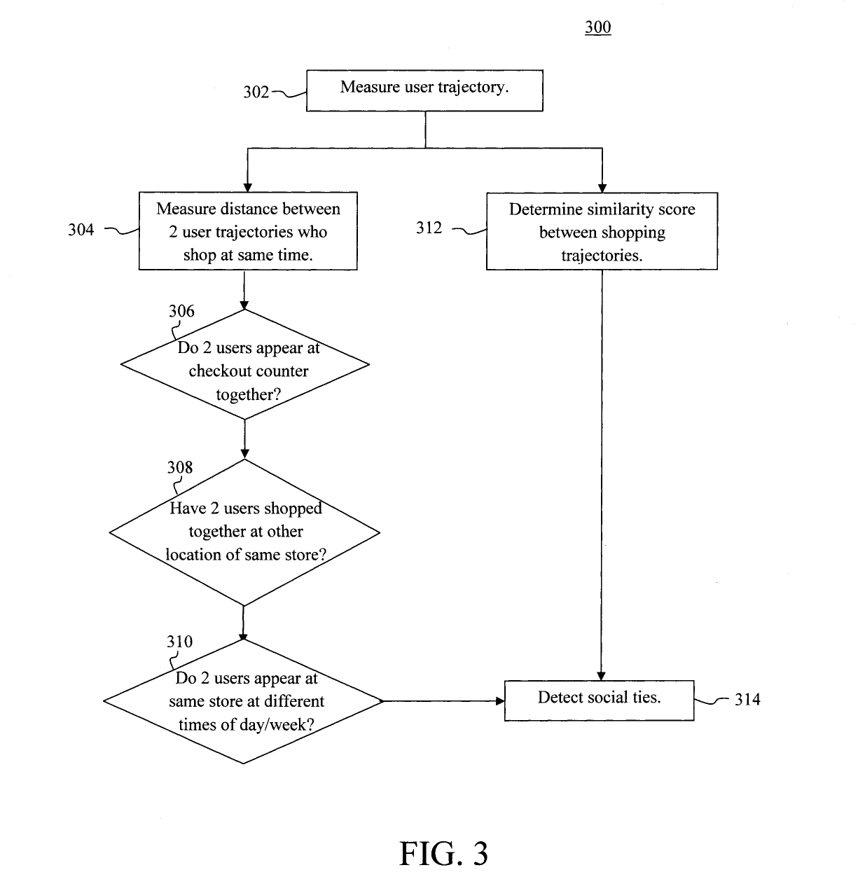

As provided above, user trajectory analysis may be leveraged herein to determine social ties amongst users. As noted above, in many real-world scenarios users with social ties often do not shop together. For instance, they often shop at different times or, when together in the same store, they often browse in different areas. In order to tie these users, an exemplary methodology 300 is provided in FIG. 3 which is based on trajectory analysis as it pertains to determining users' location history.

Namely, as shown in step 302 of methodology 300 (of FIG. 3), user trajectory is measured. By way of example only, user trajectory can be measured using WiFi, and/or any other indoor localization scheme employable within the store. According to an exemplary embodiment, the user trajectories might simply include a location and a time stamp (e.g., User A is at location x of Store 1 at 10:02 AM). Based on that data, it can easily be ascertained where in the store a user is/was, and at what time. From that knowledge, connections can be drawn between users to draw social ties.

For instance, in step 304 of methodology 300 (of FIG. 3), a distance between the trajectories of users who are detected in the store at the same time is measured. One or more features can be extracted from this distance data, such as mean distance, maximum distance, median distance, etc. By way of example only, observing user trajectories over a given period of time (ranging for example from a single visit to an extended period, e.g., a month or more) can be used to determine which users browse the store together. For instance, those users with trajectories that are within a predetermined threshold distance (mean, maximum, median, etc.) from one another can be used to indicate a common browsing path through the store. It may be inferred that these users are shopping together. Thus, drawing social ties between them might be useful in making shopping recommendations in the future. For example, User A and User B have shopped together in the past. Thus, when User A returns to the store, he/she might like to know what items User B prefers.

Another useful metric that can be used to establish social ties amongst users is determining whether the users appear at the store checkout counter together. See step 306 of methodology 300 (of FIG. 3). Namely, the store checkout counter is oftentimes a meeting point for shoppers. For instance, family members who visit a store together might browse different areas, but will group together to go through the checkout at the same time. This provides a convenient point of reference when the trajectory data for 2 (or more) users converges at the checkout counter at the same time.

So, for instance, two users (who are shopping at the same time) might browse different parts of the store. However, their ties can still be recognized based on their meeting up at the checkout counter when they are ready to leave the store. It may be useful to set a threshold number of occurrences. For instance, it may be meaningful to look at users whose appear together at the checkout counter more than once over a month-long period. That way, chance encounters can be eliminated.

Another useful metric is whether the users have shopped together in other locations of the same store in the past. See step 308. If 2 (or more) users have been detected together at other locations of the store, then it becomes increasingly more likely that these users have social ties.

A determination may also be made in step 310 as to whether the users appear at the same store at different times of the day and/or week. Basically, just like looking if the two users shop together at different locations of the store together, this metric is checking if the users shop together at the store at different times of the day, or different days of the week. This is also to eliminate chance encounters. For instance, it is possible that two unrelated users shop at a store every Sunday at 10 AM. But it is more unlikely that the same two unrelated users shop at a store every Sunday 10 AM and every Wednesday at 3 PM. If two users are spotted together at different times (in the same store) then they are likely to be related.

Each of these qualifiers (from steps 304-310) helps in automatically determining the likelihood of social ties amongst users. For instance, if the data collected indicates that two users are in close proximity to one another while browsing, check out together, and have shopped together at other locations in the past, then it is considered more likely than not that the users have social ties. By comparison, if two users happen to browse similar areas but are not present together at checkout, and have not shopped other locations together before, then it may be assumed that the similar browsing pattern is just a coincidence, and it is likely that no social ties exist. As will be described in detail below, weighting factors can be assigned to each qualifier based, e.g., on a learning algorithm of past recommendations or direct observation.

As noted above, it may be that case that users with social ties simply do not shop at the same time. However, knowing their connection is useful. In that case, one may explore whether these users look for similar types of products. To do so, one may leverage users' shopping trajectories. See step 312. Like the user trajectories, shopping trajectories relate to a specific location and time. In this case, however, one is interested in the items the user browses, picks up, etc. The items in a store are generally in a fixed location. Thus, for instance, user similarities may be governed by the items in the store they pick up in common, even if they shop at different times. A standard similarity score can be used to establish commonality based, for example, on the number of items purchased in common. Thus, to use a simple example, if User A and User B pick up only 1 item in common, the similarity score would be below a (predetermined) threshold, and no commonality might exist. However, being above the threshold score (i.e., the users have picked up multiple items in common) might indicate social ties. Again, it is noted that the various factors can be considered together in making the determination. Thus, for instance, without any other indicators of commonality, purchasing many of the same items might not be considered sufficient to socially tie 2 users. Other algorithms like dynamic time warping can also be used to measure the distance between the locations that the two users visited in their trajectory.

Based on the above-described trajectory-based metrics, in step 314 of methodology 300 (of FIG. 3) social ties are detected amongst the users. Ultimately, the goal is to make meaningful shopping recommendations to users based on the shopping preferences of their social ties. Thus, the features measured in steps 304-312 can be weighted according to their usefulness at making connections amongst users that result in useful shopping recommendations. To use a simple example, it may prove that users appearing at the checkout counter together and/or browsing the store together (see above) yield a higher value social tie-based recommendation than those based on users who frequent the same store, but at different days of the week. Thus, one might choose to weight these factors differently. The value of the recommendation might be evaluated based on feedback from the user. Say, for instance, that based on methodology 300 (of FIG. 3) a connection is made between User A and User B. When User A is shopping, a recommendation is made for a product that User B likes. If User A then purchases the product, the recommendation has a high value. User A might also actively, e.g., via his/her mobile device, accept or dismiss the recommendation.

The weights assigned to the features can be application-specific. For instance, user shopping patterns can vary depending on the types of store, location, etc. and thus different factors can be useful in determining social ties. For instance, users might browse differently in a supermarket than they would in a convenience store, or a clothing store, or a department store that has a variety of different categories of products. According to one exemplary embodiment, weights are assigned to the features using a learning algorithm that evaluates past social ties based on the value of the recommendations. Thus, for instance, the process might begin with all of the above-described features being given an equal weight. However, it is found over time that the recommendations based on social ties drawn using some of the features are better than those drawn using other features. The features can then be weighted accordingly to yield more meaningful recommendations.

Alternatively, in another exemplary embodiment, volunteers can be recruited to explicitly get the ground truth. For instance, shoppers can be asked to evaluate the recommendations via their mobile devices. A volunteer shopper can be given recommendations as they browse the store such as “you might like this product” or “this product is on sale.” The volunteer shopper can then evaluate the recommendation, such as accept, dismiss, apply a rating system, etc. Incentives can be provided to the volunteers for their compliance, e.g., via coupons, gift cards, etc. This can help weight the usefulness of the several heuristics explained above in detecting social ties.

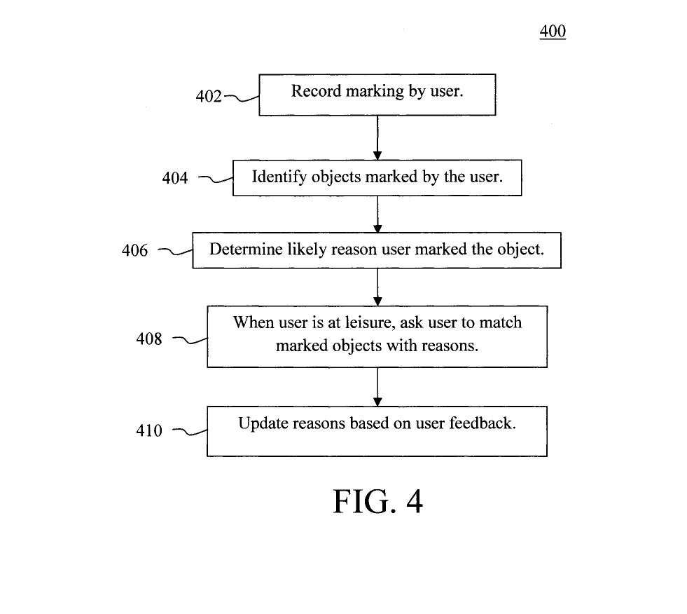

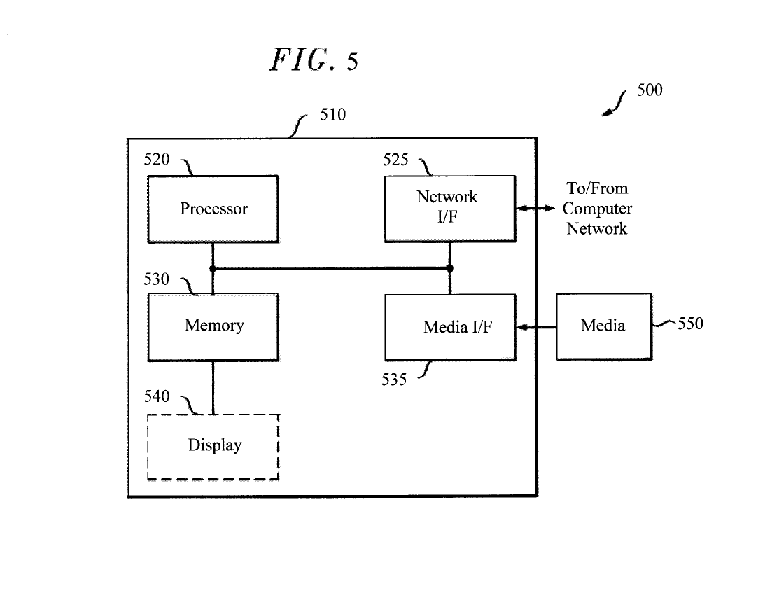

As provided above, the present techniques leverage a user's shopping preference data. In that regard, methodology 400 of FIG. 4 provides a unique way by which users, when shopping, can mark certain products in a store that they like. This data can then be used in the present recommendation engine. The steps of methodology 400 can be performed by a marking engine embodied, for example, in an apparatus such as apparatus 500 of FIG. 5, described below.

The ability to ‘like’ content online is widely used. In the physical context of shopping, it is more powerful as the user can see, feel, test out the product, etc. However, the user might not want to take the time while browsing the store to stop and tell social ties why the user likes this product. The present techniques offer the advantage to permit users to quickly/easily mark products while they are shopping (e.g., by taking a picture, scanning a barcode, etc.) and then, when at leisure, the user can provide details on why he/she has tagged a certain product.

Namely, in step 402 of methodology 400 (of FIG. 4), products marked by the user (when the user is shopping) are recorded. The user may mark products easily by taking an image of the product (e.g., using their smartphone camera, smartglasses, etc.) and/or by scanning the barcode on the product. This marked data from the users' mobile devices is stored in the present system.

In step 404 of methodology 400 (of FIG. 4), the objects (i.e., products) marked by the user (in step 402) are identified. According to an exemplary embodiment, when the user captures an image of the product, the system determines the location of the user when the image was captured (based for example on user trajectory—see above) and then uses image matching techniques to match the image captured by the user to images of products in that location of the store. Barcode data, on the other hand, uniquely identifies a product. Thus, if the user scans the barcode, then the product information can be directly retrieved.

In step 406 of methodology 400 (of FIG. 4), the system attempts to determine a reason the user marked the product. This will aid in obtaining further information from the user at his/her leisure—see below. For instance, it may be determined that the user has purchased the product in the past and thus it is a product the user likes. The system might also look to see if there are current deals on the product (e.g., the product may be on sale). This might explain why the user has marked the product.

It might also be useful to know whether the product is popular with other users. For instance, the user might have marked the product since it is a popular newly released book, movie, etc. This information would be useful in making recommendations to the user's social ties.

When it is detected that the user is at leisure, in step 408 of methodology 400 (of FIG. 4), the user is presented with the reasons (deduced in step 406), and asked to match the reasons with the products the user marked (in step 402). In this manner, the user does not have to take the time while shopping to expound on the products he/she has marked, but is prompted later when he/she has free time to do so. It can be detected that the user is at leisure (e.g., in a train/bus, waiting at a train station, playing a game on his/her smartphone, etc.) based on the sensors (like GPS for location, accelerometer to detect whether user is static/moving in bus/train etc.) in the user's smartphone. Also presenting the reasons deduced in step 406, will make marking easy for the user.

By way of example only, the user can be presented (on his/her mobile device) with the marked products and a selection of the reasons for marking the products. The user can then select the right reason (or provide another reason). According to an exemplary embodiment, this validation process can be presented to the user in the form of a game wherein (optionally) incentives to participate can be offered (such as coupons, gift cards, etc.). Feedback regarding how many of the recommended products the user's social ties found useful (e.g., purchased, liked, etc.) can be used to judge the user's score, and the incentives can be provided accordingly.

Finally, in step 410 of methodology 400 (of FIG. 4), based on the feedback from the user, the reasons for marking the products are updated in the system. This will be useful in making the recommendations to the user's social ties. For instance, when making a recommendation, the system might highlight that the product is on sale, or is a popular new item, etc. The feedback from the user also helps the system make better guesses for future products the user marks.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Turning now to FIG. 5, a block diagram is shown of an apparatus 500 for implementing one or more of the methodologies presented herein. By way of example only, apparatus 500 is representative of any of the Recommendation/Marking Engines local to any of the stores shown in FIG. 1, and can be configured to implement one or more of the steps of methodology 200 of FIG. 2, methodology 300 of FIG. 3, and/or methodology 400 of FIG. 4.

Apparatus 500 includes a computer system 510 and removable media 550. Computer system 510 includes a processor device 520, a network interface 525, a memory 530, a media interface 535 and an optional display 540. Network interface 525 allows computer system 510 to connect to a network, while media interface 535 allows computer system 510 to interact with media, such as a hard drive or removable media 550.

Processor device 520 can be configured to implement the methods, steps, and functions disclosed herein. The memory 530 could be distributed or local and the processor device 520 could be distributed or singular. The memory 530 could be implemented as an electrical, magnetic or optical memory, or any combination of these or other types of storage devices. Moreover, the term “memory” should be construed broadly enough to encompass any information able to be read from, or written to, an address in the addressable space accessed by processor device 520. With this definition, information on a network, accessible through network interface 525, is still within memory 530 because the processor device 520 can retrieve the information from the network. It should be noted that each distributed processor that makes up processor device 520 generally contains its own addressable memory space. It should also be noted that some or all of computer system 510 can be incorporated into an application-specific or general-use integrated circuit.

Optional display 540 is any type of display suitable for interacting with a human user of apparatus 500. Generally, display 540 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for making shopping recommendations, the method comprising:
collecting shopping data from users, wherein the users comprise a first user and one or more second users with social ties to the first user; and
making recommendations to the first user based on the shopping data while the first user is shopping at a store, wherein the recommendations include preferences of the second users with social ties to the first user.

2. The method of claim 1, wherein the second users with social ties to the first user comprise one or more of family and friends of the first user.

3. The method of claim 1, wherein the shopping data comprises past purchases.

4. The method of claim 1, wherein the shopping data comprises browsing history.

5. The method of claim 1, wherein the shopping data is collected using a surveillance system in the store.

6. The method of claim 1, wherein the shopping data is collected using electronic beacons in the store.

7. The method of claim 1, wherein the shopping data is collected using mobile devices of the users, the method further comprising:
retrieving the shopping data from the mobile devices of the users.

8. The method of claim 1, further comprising:
determining social ties amongst the users.

9. The method of claim 8, wherein the social ties amongst the users are determined based on a presence of the users in a same store at a same time more than a predetermined threshold number of times over a predetermined time period.

10. The method of claim 9, further comprising:
determining the presence of the users based on a presence of mobile devices carried by the users.

11. The method of claim 1, wherein the recommendations are made to the first user on one or more mobile devices of the first user.

12. The method of claim 11, wherein the mobile devices of the first user comprise at least one of a smartphone, a smartwatch, and smartglasses.

13. The method of claim 1, wherein the shopping data is collected from the users while shopping at multiple stores, the method further comprising:
retrieving the shopping data from one or more of the multiple stores.

14. The method of claim 1, further comprising the steps of:
identifying products marked by the user when shopping at the store;
determining reasons the users might have marked the products; and
when the users are at leisure, asking the users to match the reasons with the products.

15. The method of claim 14, wherein the products are marked by the users by one or more of capturing images of the products or scanning barcodes of the products using mobile devices of the users.

16. The method of claim 14, further comprising the step of:
providing incentives for the users to match the reasons with the products.

17. A computer program product for making shopping recommendations, the computer program product comprising a computer readable storage medium having program instructions embodied therewith, the program instructions executable by a computer to cause the computer to:
collect shopping data from users, wherein the users comprise a first user and one or more second users with social ties to the first user; and
make recommendations to the first user based on the shopping data while the first user is shopping at a store, wherein the recommendations include preferences of the second users with social ties to the first user.

18. The computer program product of claim 17, wherein the program instructions further cause the computer to:
determine social ties amongst the users.

19. The computer program product of claim 17, wherein the shopping data is collected from the users while shopping at multiple stores, and wherein the program instructions further cause the computer to:
retrieve the shopping data from one or more of the multiple stores.

20. A system for making shopping recommendations, the system comprising:
at least one store comprising a recommendation engine configured to: collect shopping data from users, wherein the users comprise a first user and one or more second users with social ties to the first user; and make recommendations to the first user based on the shopping data while the first user is shopping at the store, wherein the recommendations include preferences of the second users with social ties to the first user.

21. The system of claim 20, wherein the recommendation engine is further configured to: determine social ties amongst the users.

22. The system of claim 21, wherein the at least one store further comprises: a marking engine configured to: identify products marked by the user when shopping at the store; determine reasons the users might have marked the products; and when the users are at leisure, ask the users to match the reasons with the products.

23. The system of claim 21, wherein the system comprises multiple stores, and wherein the recommendation engine is further configured to: retrieve the shopping data from one or more of the multiple stores.
